(19) United States
(12) Patent Application Publication
(10) Pub. No.: US 2008/0158336 A1
(43) Pub. Date: Jul. 3, 2008

(54) Real time video streaming to video enabled communication device, with server based processing and optional control

(76) Inventors: Richard Benson, Montreal (CA); Edouard Boily, Montreal (CA); Carine Le Discorde, St-Mathias sur Richelieu (CA); Francois Paquet, Laval (CA)

Correspondence Address: POSZ LAW GROUP, PLC, 12040 SOUTH LAKES DRIVE, SUITE 101, RESTON, VA, 20191, US

(21) Appl. No.: 11/907,108

(22) Filed: Oct. 9, 2007

Related U.S. Application Data
(60) Provisional application No. 60/850,622, filed on Oct. 11, 2006.

(51) Int. Cl. H04N 7/14

(52) U.S. Cl. 348/14.08; 348/E07.077

(57) ABSTRACT

A method, system, device, and computer storage medium for use in communicating a video feed transmitted from a video monitoring device to a video enabled communication device. The video enabled communication device and the video monitoring device communicate via a communication network in a session initiation protocol (SIP) session. In accordance with a SIP initiation path, a SIP session is established between the video monitoring device and the video enabled communication device. After establishing the SIP session, in accordance with a media path between the video monitoring device and the video enabled communication device, a video feed is received from the video monitoring device. The received video feed is transcoded. In accordance with the media path, the transcoded video feed is transmitted to the video enabled communication device.

### CROSS-REFERENCE TO RELATED APPLICATIONS

This application claims the benefit of U.S. Provisional Application Ser. No. 60/850,622 filed Oct. 11, 2006, which is expressly incorporated herein by reference.

### TECHNICAL FIELD

The technical field relates in general to communication devices and networks, and more specifically to video streaming from a video monitoring device (such as a webcam) to a video enabled communication device.

### BACKGROUND

Any of the existing technologies for delivering a video stream from a web camera to a video phone only focus on one or few aspects of the end-to-end delivery requirements. For example, conventional technologies are either a camera with a client application on a personal computer (PC), or a camera with software that can detect movement and send alerts.

In the first technology mentioned above, the camera has a client application on the PC, into which the camera is hooked, or a network camera is connected to a router via a RJ-45 wire or via WIFI (wireless fidelity), with an integrated web server. Those cameras can be accessed via a web browser or a client application to view the video feed. Mobile phones can access the camera video feed with integrated web browser and media viewer. However, these solutions do not have telephony integration that uses SIP (session initiation protocol) to connect the video feed with one of the following devices: SIP/video softphone, SIP/video device, or other type of video enabled phone.

In the second technology mentioned above, the software associated with the camera can detect movement and send alerts to the user. These alerts include e-mails, IM (instant messages), SMS (short message service, sometimes referred to as “text messaging”), and a phone call with a voice message. However, the camera's software does not make a phone call, on which the user can see the video live stream when he answers the call with a video enabled phone. These solutions can also send alerts on movement detection, but do not send alerts triggered by other triggers, such as heat sensitive sensors, or light sensitive sensors.

There also are solutions that use the web browser to control or select a web camera. However, they have not addressed the ability to control or select the web camera using the buttons directly from the video enabled communication device using DTMF (dual tone multi-frequency), nor with speech recognition commands.

There is a solution that includes cameras that are connected on a system control module on the client side, that use voice over IP capabilities to call the user upon movement detection, and send video stream. This system control module allows the user to access and control his camera via a telephone call. However, this system is on the client site and is not centralized, that is, it is used at only one site, not by many sites or many customers at the same time. With this application, the user can only access connected cameras on the communication device, but not any cameras on the Internet. In addition, this solution only allows alerts on movement detection, but not on other triggers.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a diagram illustrating a simplified and representative environment associated with a video monitoring device and a video enabled communication unit and exemplary network;

FIG. 2 is a block diagram illustrating components used with a protocol for communications between a video monitoring device and a video enabled communication unit;

FIG. 3 is a diagram illustrating a communication protocol for communications triggered by a sensor;

FIG. 4 is a diagram illustrating an exemplary network infrastructure device in accordance with various exemplary embodiments;

FIG. 5 is a diagram illustrating a protocol sequence for home surveillance using the video monitoring device and the video enabled communication unit;

FIG. 6 is a diagram illustrating a protocol sequence for monitoring the video monitoring device; and

FIG. 7 is a high level flow chart illustrating a procedure for a video enabled communication device/video monitoring device communication session.

### DETAILED DESCRIPTION

In overview, the present disclosure concerns communication devices, such as cellular phone or two-way radios and the like having a capability of displaying a video feed, such as may be associated with a communication system such as an Enterprise Network, a cellular Radio Access Network, or the like. Such communication systems may further provide services such as voice and data communications services. More particularly, various inventive concepts and principles are embodied in systems, communication units, and methods therein for providing video from a video monitoring device to a video enabled communication unit, or vice-versa, via a call in a communication network.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to provide a way to visually monitor a home, an office, or some physical space when a user is away from it using a camera, and an alert will be triggered by the end video capturing device or another device via motion, heat, sound or other triggers. These methods, systems, and devices give the subscriber a much better utility of (1) remotely monitoring something without consistently sitting at the same physical space, (2) monitoring something without any triggers (therefore continuous monitoring by the person), (3) and also allowing subscribers the freedom to receive the real time video on to any of the following device, which are listed as examples: SIP (session initiation protocol)/video softphone, SIP/video device, video enabled phone, with signaling/media gateway and live transcoding unit on carrier side, as in IMS (Internet protocol multimedia subsystem) architecture. These methods, systems and devices also allow the user to have these capabilities without having to own telephony equipment, with all of the telephony functionality done on the server side. Example applications which can utilize these methods, systems and device include home or office surveillance and a virtual nanny (sometimes referred to as a “dial-a-cam”), discussed in more detail below.

In the home or office surveillance system, a user's webcam can call the user and stream video to the user's video enabled communication device when a movement is detected at home or office, for example. This can allow users to securely receive a live video stream from their webcams and see the real-time stream, for example from a web browser or video enabled softphone or 3G phone, as soon as the webcam detects a movement. The home or office surveillance system can leverage SIP servlet technology to connect a mobile phone or softphone to a customer home camera video/audio feed via the mobile telephone communication network.

Further in accordance with exemplary embodiments, there is provided a sensor enabled or motion detected real time video streaming to video phone, with server based telephony integration and control, leveraging SIP technology, and/or with dial-a-cam capability to remotely pick and control cameras.

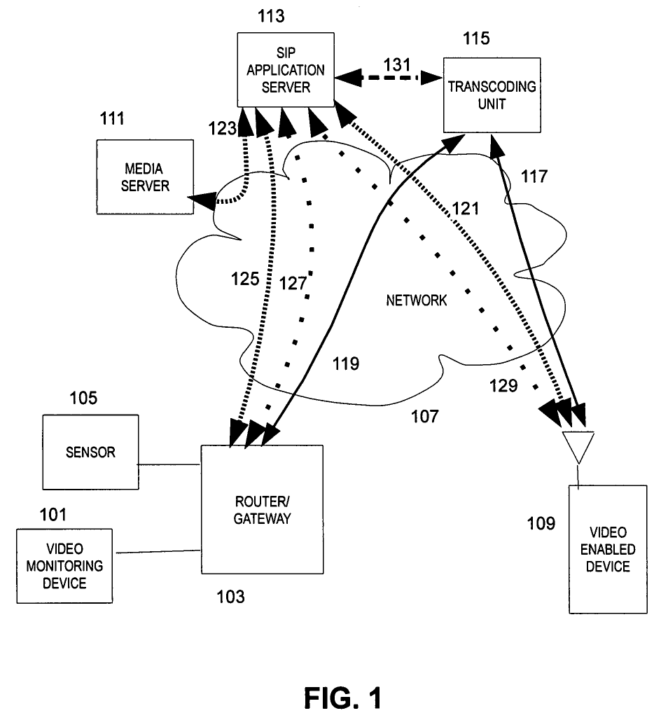

Referring now to FIG. 1, a diagram illustrating a simplified and representative environment associated with a video monitoring device and a video enabled communication unit and exemplary network will be discussed and described. In this diagram, there are illustrated a video monitoring device 101, a router/gateway 103, a sensor 105, a network 107, a video enabled communication device 109, a media server 111, a SIP application server 113, and a transcoding unit 115.

The video monitoring device 101 and sensor 105 communicate with the network 107 via the router/gateway 103, in accordance with known techniques. The SIP application server 113 can include a camera management component to receive triggers from one or more video monitoring devices 101 and to act upon them by initiating a SIP session so that the video enabled device 109, the video monitoring device 101 and the transcoding unit 115 can be established. Alternatively, if the video monitoring device 101 is SIP enabled, the router can simply route the SIP packets from the video monitoring device 101. If the video monitoring device 101 is not SIP enabled, the router/gateway 103 can act as a signaling/media gateway to convert the SIP messages to/from the video monitoring device 101. The sensor 105 is representative of one or more sensors, which can be incorporated in and/or connected to the video monitoring device 101.

Various network infrastructure devices, including the media server 111, the SIP application server 113, and the transcoding unit 115 can be accessed via communications on the network 107. Communication packets are routed 127, 129 through the SIP application server 113 in order to establish a SIP session between the video monitoring device 101 and the video enabled communication device 109. Accordingly, one or more embodiments further includes communication packets routed 121, 123, 125 from the video enabled device 109 to the video monitoring device 101 through the SIP application server 113 in order to establish a SIP session between the video monitoring device 101 and the video enabled communication 109. Once the SIP session is established, communication packets including the video feed between the video monitoring device 101 and the video enabled communication device 109 are routed along a media pathway 117, 119 through the transcoding unit 115. Communication packets allowing the video enabled communication device 109 to control the video monitoring device 101 are routed in a control pathway 121, 123, 125 through the SIP application server 113 and the media server 111. Accordingly, one or more embodiments further includes transcoding the received video feed, wherein the video feed that is transmitted to the video enabled communication device has been transcoded, wherein the transcoding is performed in a transcoding unit at a network infrastructure device routing communications in the media path.

More particularly, the SIP application server 113 receives a signal from the video monitoring device 101, determines a subscriber associated with the video monitoring device, and calls the communication device 109 associated with the subscriber. Alternatively, the SIP application server 113 receives a signal from the video enabled communication device 109, determines a subscriber associated with the video enabled communication device 109, determines a video monitoring device 101 associated with the subscriber, and calls the video monitoring device 101 associated with the subscriber. The SIP application server 113 sends an instruction 131 to the transcoding unit 115 to receive the video feed from the video monitoring device 101, transcode it into the proper format for the communication device 109, and stream the transcoded video feed to a destination, that is the communication device 109. Then, the SIP application server 113 is informed when the call terminates, and the SIP application server 113 can perform a tear down of the SIP session.

Accordingly, there is provided a method, system device, and/or computer readable medium for communicating a video feed transmitted from a video monitoring device to a video enabled communication device, wherein the video enabled communication device and the video monitoring device communicate via a communication network in a session initiation protocol (SIP) session. The method includes establishing, in accordance with a SIP initiation path, a SIP session between the video monitoring device and the video enabled communication device. Also, the method includes after establishing the SIP session, receiving, in accordance with a media path between the video monitoring device and the video enabled communication device, a video feed from the video monitoring device; transcoding the received video feed; and transmitting, in accordance with the media path, the transcoded video feed to the video enabled communication device.

Furthermore, one or more embodiments provides a method, system, device, and computer readable medium for communicating a video feed transmitted from a video monitoring device to a video enabled communication device, wherein the video enabled communication device and the video monitoring device communicate via a communication network in a session initiation protocol (SIP) session, and wherein a sensor communicates via the communication network, the sensor being triggered by a predetermined condition. In accordance with a SIP initiation path, a SIP session is established between the video monitoring device and the video enabled communication device, wherein the SIP session is initiated by a sensor being triggered by a predetermined condition. After establishing the SIP session, a video feed is received from the video monitoring device, in accordance with a media path between the video monitoring device and the video enabled communication device. In accordance with the media path, the received video feed to the video enabled communication device, in accordance with the media path.

In a practical example of FIG. 1, two webcams are connected (as the video monitoring device 101 and sensor 105) to a DELL laptop running SPOTxde LIVE software. The laptop can be connected via the router/gateway 103 to the network 107, such as the Internet, and provisioned to a communication service provider in order to associate the laptop with a subscriber in accordance with known techniques. The laptop can have a static public address. The video enabled communication device 109 is provided with an available EYEBEAM SIP video softphone (or the like) running on a second DELL laptop. The SIP server 113 can run a home surveillance application. When one of the webcams detects a movement, it calls the softphone as further described herein. Of course, other embodiments can use the above principals and techniques in connection with other types of devices.

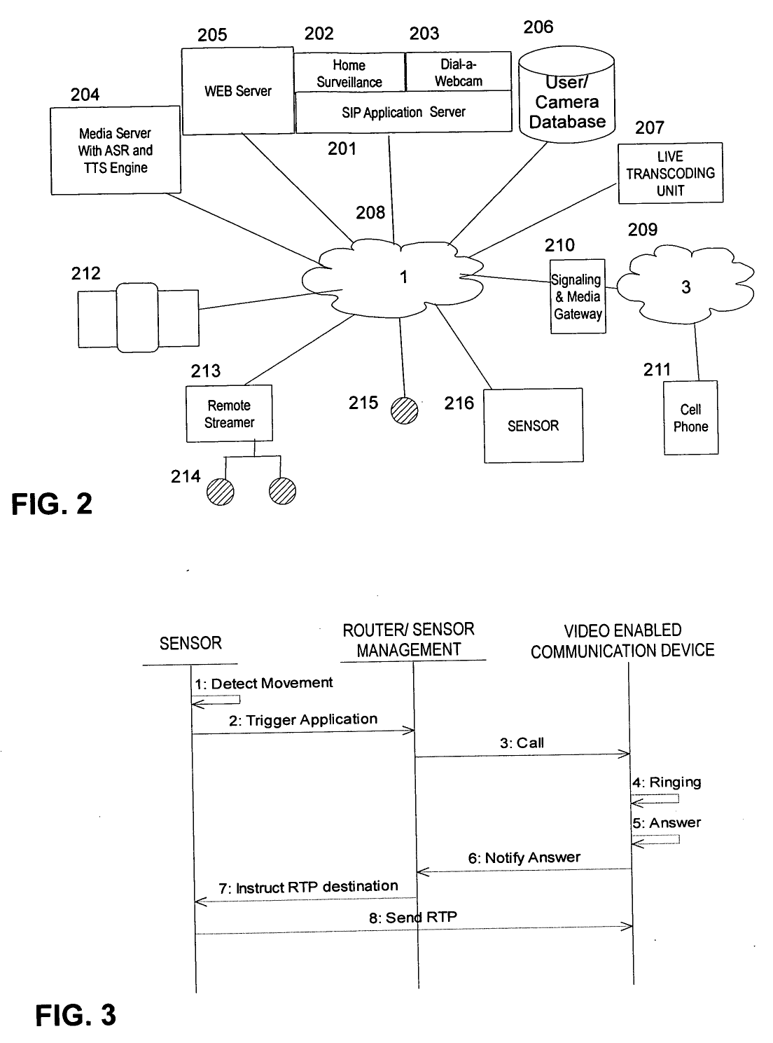

Referring now to FIG. 2, a block diagram illustrating components used with a protocol for communications between a video monitoring device and a video enabled communication unit will be discussed and described. The illustrated components are for an embodiment with a camera connected to a computer.

In FIG. 2, a SIP application server 201 can be a SIP application server that can run a SIP Servlet. A home surveillance SIP application 202 can be a SIP application used to control the flow between the user, the camera and the media server. This application can call the user when a movement is detected in front of the camera or after a sensor detects any other trigger.

A dial-a-webcam SIP application 203 can be used to control the flow between the user, the camera and the media server. This application can be called by the user's communication device, when the user wants to see a video feed from one of his video monitoring devices, for example, from one or more cameras.

A media server 204 can include an IVR (interactive voice response) function. It also can be used to detect DTMF (dual tone multi-frequency) from the communication device on the user side. The detected DTMF can be used to interact with and control the camera (to control the camera's zoom, tilt, pan, and so forth). Accordingly, one or more embodiments includes interpreting dual tone multi-frequency (DTMF) tones received from the video enabled communication device as video monitoring device control for the video monitoring device; and transmitting the video monitoring device control to the video monitoring device. Furthermore, in one or more embodiments, the interpreting includes interacting with a media server to translate the DTMF tones to the video monitoring device control for the video monitoring device. Alternatively, one or more embodiments includes receiving SIP information packets from the video enabled communication device to the video monitoring device, wherein the SIP information packets include video monitoring device control and indicate the video monitoring device to be controlled; and transmitting the SIP info packets to the indicated video monitoring device, so that the video monitoring device is controlled.

A web server 205 can be a server optionally used to generate VoiceXML scripts for the media server.

A user/camera database 206 can be a database that contains associations between camera identifiers and user's phone numbers.

A live transcoding unit 207 can be used to transform the video stream from the video monitoring device into a format that the communication device can display. According to one or more embodiments, therefore, the transcoding is performed in a transcoding unit at a network infrastructure device routing communications in the media path.

An IP network 208 can be an Internet, local area network (LAN), or other communication network connected to the Internet.

A 3G network 209 can be a 3G mobile phone network, and is representative of a packet communication network used to communication with communication devices.

A signaling and media gateway 210 can be a gateway used to convert voice over IP (VoiP) signaling and media into signaling appropriate for the packet communication network, for example 3G signaling and media.

A communication device such as a mobile phone 211 can include on call video capability. For example, a video/SIP phone 212 can be a SIP phone with in-call video capability.

A remote streamer 213 can be an application that runs on a PC (personal computer) where the cameras are connected, for example utilizing a USB (universal serial bus) connection. This could be, for example, the application that comes with the cameras or a custom application adapted for the described applications. This application can expose web services and/or a RMI (remote method invocation) API (application programming interface) to control the camera. This application can also call a web service or a RMI application, or send an e-mail, or transfer a file with ftp (file transfer protocol), upon movement detection by the camera(s) or other sensor connected to the camera. Other interface(s) can also be used to indicate motion detection.

Also illustrated is a camera 214, for example a camera connected to a PC, used by the Remote Streamer 213.

Also illustrated is a network camera 215, for example, a camera with an integrated web server. This web server can expose a web service API to control the camera. This camera can be able to call a web service or a RMI application, or send an e-mail, or transfer a file with ftp, on movement detection. Other interfaces can also be used to indicate motion detection.

In some embodiments, one or more sensors 216 can be used to trigger the home surveillance application. When a specified event (temperature, light, or the like) occurs, the sensor can call a web service or a RMI application, or sends an e-mail, or transfers a file with ftp, on movement detection. Other interfaces can also be used to trigger the home surveillance system.

In one set-up, discussed merely as an example, an eyeBeam softphone can reside on a Dell D610 and allows users to manage their voice, video, IM and presence applications on their desktop solution. It uses Session Initiated Protocol (SIP) based signaling for all interactive media sessions. A Home Surveillance Application resides on a SIP Server and controls the call flow. The SPOTxde LIVE server, available from Vantrix, resides on the second Dell D610 and handles transcoding and translating of live video/audio streams. It is used for realizing the transformation and conversion of rich media audio and video streams in real-time.

One application of this system is sometimes referred to as the “home surveillance” system, in which a user's webcam (or other video monitoring device) calls the user's video enabled communication device and streams video to the communication device when a movement (or other trigger) is detected at home. The home surveillance system allows users to securely receive a video stream from their webcams and see the real-time stream from a web browser or a video enabled soft phones or 3G phones as soon as the webcam detects a movement, utilizing a SIP application server (such as the UBIQUITY SIP application server).

The home surveillance system can include a SIP application server, a motion detector (in-camera or in streamer) (or other sensor), a transcoding unit (for example SPOTxdeTM Live available from Vantrix Networks), and a video enabled communication device (for example, an eyeBeam video enabled softphone).

In the home surveillance system, the following sequence can occur. First the webcam detects movement (or other sensor detects trigger). Then, the webcam transmits a message to the home surveillance system. The home surveillance system calls the video enabled communication device associated with the user. The communication device answers, and the home surveillance system connects the video stream to the user's communication device. The communication device receives the video stream from the webcam. When completed, the video enabled communication device hangs up to terminate the communication.

In a first step of the home surveillance system, the webcam (for example running a SPOTxdeLive application) detects a movement greater than the detection threshold, which is used as the trigger. The detection threshold is constructed from two parameters: frame rate and percentage of image change.

In a second step of the home surveillance system, the webcam transmits a SIP INVITE message to the SIP application server. The SIP application server then triggers the home surveillance system. Alternatively, the webcam triggers a camera manager component (typically not using SIP) that instructs the SIP application server to establish a session between the webcam, the transcoding unit, and the user's video enabled communication device, using SIP.

In a third step of the home surveillance system, the home surveillance system sends a SIP INVITE message to the video enabled communication device associated to the camera. The home surveillance system then connects the webcam to the user's video enabled communication device.

In a fourth step of the home surveillance system, the webcam streams RTP (real time transport protocol) directly to the user's phone.

An alternative application is sometimes referred to as the “virtual nanny” system, which allows a user to remotely access a webcam and monitor their house, for example. More particularly, the virtual nanny system can allow users to securely access their webcams and see the real-time stream from, for example, a web browser or a video enabled soft phones or 3G phones. Optionally, the virtual nanny system can leverage a SIP application server to interact with a VoiceXML platform.

The virtual nanny system can include a SIP application server, a web server (to play a VoiceXML script menu and/or to present an HTML menu), an interactive voice response system (for example, NUANCE), speech recognition and/or DTMF functionality, and a transcoding unit such as SPOTxde Live available from Vantrix Networks. For PSTN access, a softswitch can be provided.

In the virtual nanny system, the following sequence can occur. First, a video enabled communication device is prompted by a user to dial the virtual nanny, and dials the virtual nanny. Next, the system recognizes the callerid associated with the call and optionally transmits a request for the password. In response to the request for the password, the video enabled communication device receives a PIN/password from the user and verifies authorization. The virtual nanny then interacts with the user on the video enabled communication device to determine which camera the user wants to see. The video enabled communication device receives a user selection of the desired webcam. The virtual nanny system instructs the video enabled communication device to prepare to receive video stream. The video enabled communication device receives the video stream from the webcam. When completed, the video enabled communication device hangs up to terminate the communication.

In a first step of the virtual nanny system, the user's video enabled communication device sends a SIP INVITE to a SIP server (for example, Ubiquity). The SIP server triggers the virtual nanny system.

In a second step of the virtual nanny system, the virtual nanny system includes a VoiceXML script and transmits an INVITE to the media server to play the script to the User via the video enabled communication device. The virtual nanny connects the user's video enabled communication device and the media server. The user can interact with the video enabled communication device to indicate the selected camera. The DTMF corresponding to the selected camera is collected and communicated to virtual nanny system.

In a third step of the virtual nanny system, the virtual nanny system sends a SIP INVITE to a transcoding unit, for example a SPOTxdeLive server, and connects the transcoding unit to the user's video enabled communication device.

In a fourth step of the virtual nanny system, the transcoding unit streams the RTP data directly to user's video enabled communication device.

The following is an overview of the packet flow which occurs in a basic use case of the home surveillance application, the beginning of which generally corresponds to the sequence diagram illustrated in FIG. 3 and discussed below. First, a sensor (for example on the video monitoring device or separately connected to a router/gateway) detects movement (or other trigger). Second, the video monitoring device (such as the webcam) sends a message to a home surveillance application. Third, the home surveillance application calls the user's video enabled communication device. Fourth, the user answers the video enabled communication device. Fifth, the home surveillance application connects the video stream from the video monitoring device to the user's video enabled communication device. Sixth, the user's video enabled communication device receives the video stream from the webcam. Finally, the user's video enabled communication device hangs up.

Referring now to FIG. 3, a diagram illustrating a communication protocol for communications triggered by a sensor will be discussed and described. At step 1, a video monitoring device detects a movement greater than the detection threshold. The detection threshold is constructed from two parameters: frame rate and percentage of image change. Other triggers and sensors can be used. The triggers, sensors, and streaming/transcoding unit are available as conventional technology.

At step 2, in response to the sensor, a packet is transmitted to the router/sensor management to trigger the home surveillance application. The packet is transmitted in accordance with known techniques and protocols.

At step 3, the home surveillance application determines the contact information for the video enabled communication device associated with the camera (or other video monitoring device), and calls that video enabled communication device.

At step 4, the user's video enabled communication device is ringing. At step 5, the user's video enabled communication device answers the call.

At step 6, the home surveillance application receives a notification that the call was answered. At step 7, the home surveillance application instructs the camera to send RTP (real-time transport protocol) communications to the user's video enabled communication device. At step 8, the camera begins streaming the video feed as RTP to the user's video enabled communication device. The streaming of the video feed can continue until the call is terminated.

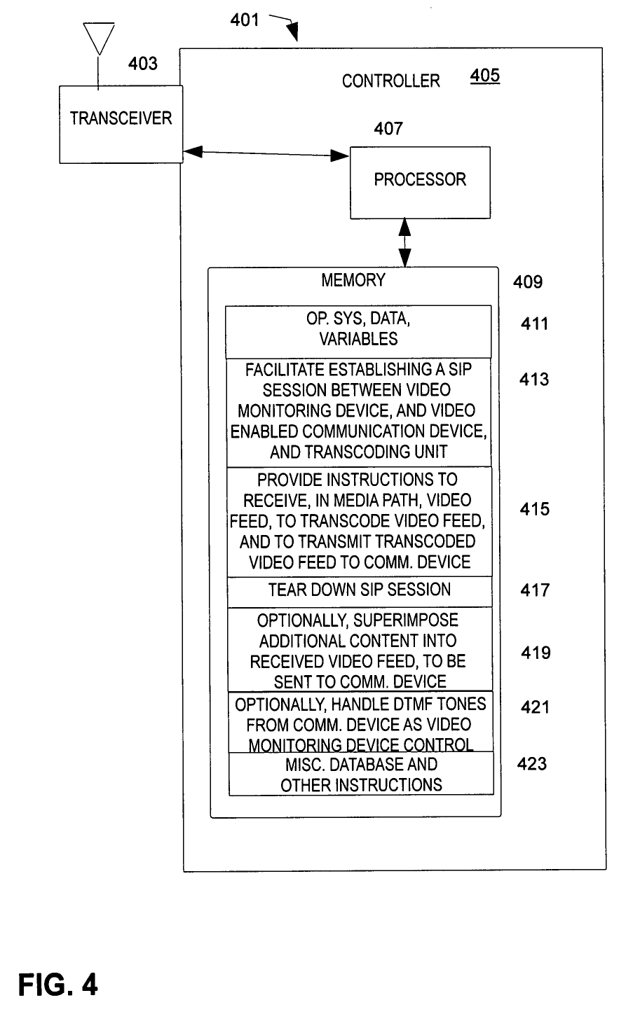

Referring now to FIG. 4, a diagram illustrating an exemplary network infrastructure device in accordance with various exemplary embodiments will be discussed and described. Some portions of the network infrastructure device which are well understood are omitted to avoid obscuring this description. The network infrastructure device can be used to route and handle various communication sequences and packet processing between a communication device and a video monitoring device.

The network infrastructure device 401 may include and one or more controllers 405. Included in the controller 405 are a processor 407 and a memory 409. The network infrastructure device 401 can also include or be connected to various other optional input/output devices such as a keypad (not illustrated), a display (not illustrated), a speaker (not illustrated), or a microphone (not illustrated).

The network infrastructure device 401 may be equipped with a receiver and transmitter or other communication port, represented here by transceiver 403, which can communicate over a wireless or wired connection with a packet network, for example a broadband network, or a voice over IP (VOIP) network, or a cellular communication network in connection with well known communication protocols.

The processor 407 can be connected to the transceiver 403 using components that are well understood and therefore will not be discussed herein. The processor 407 may be programmed for receiving and transmitting packets (e.g., bridging, routing, or switching) on the transceiver 403 which are routed between the video monitoring device and the video enabled communication device, in accordance with conventional techniques.

The processor 407 may comprise one or more microprocessors and/or one or more digital signal processors. The memory 409 may be coupled to the processor 407 and may comprise a read-only memory (ROM), a random-access memory (RAM), a programmable ROM (PROM), an electrically erasable read-only memory (EEPROM), and/or a flash memory. The memory 409 may include multiple memory locations for storing, among other things, an operating system, data and variables 411 for programs executed by the processor 407; computer programs for causing the processor to operate in connection with various functions such as facilitating 413 establishment of a SIP session, providing 415 instructions to receive, transcode and transmit the video feed, tear down 417 the SIP session, optionally superimpose 419 additional content into the received video feed, optionally handle 421 DTMF tones from the communication device, and/or other processing; and a database 423 for other information used by the processor 407. The computer programs may be stored, for example, in ROM or PROM and may direct the processor 407 in controlling the operation of the network infrastructure device 401. Each of these computer programs is discussed by way of example below.

The processor 407 may be programmed for facilitating 413 establishment of a SIP session between the video monitoring device, and the video enabled communication device; and then further establishing the session to include the transcoding unit. Typically a SIP session is established by routing communication through a SIP server. In this case, the SIP server is separate from the present network infrastructure device. For convenience, the SIP server and the present network infrastructure device can be referred to as a “network infrastructure system.” However, it should be understood that after the SIP session is established, the packets with the video feed are not routed through the SIP server.

The processor 407 also may be programmed for providing 415 instructions to receive the video feed in the media path, to transcode the video feed, and to transmit the transcoded video feed to the communication device. Advantageously, the instructions can be provided to a transcoding unit (which can be a separate server) that transcodes the content of the video feed, and also transmits the transcoded video feed to the video enabled communication device. The processor 407 can supply the transcoding unit with the input format and the output format, to permit successful transcoding. Also, the processor 407 can facilitate the exchange of function information between the transcoding unit, the video monitoring device, and the video enabled communication device in accordance with standard SIP establishment protocol, so that packets with the video feed can be routed more efficiently, without involving the processor 407 which established the SIP session. An appropriate transcoding unit is the SPOTLIVE product from Vantrix, which can be installed on a separate server. Accordingly, one or more embodiments further includes a transcoding unit, wherein the SIP session is established further including a transcoding unit, and the instructions to receive, transcode, and transmit are provided to the transcoding unit.

In addition, the processor 407 can be programmed to tear down 417 the SIP session that was established, in accordance with known techniques. For example, the processor 407 can instruct a SIP application server that established the SIP session to tear down the session by transmitting a BYE command.

Optionally, the processor 407 can be programmed to superimpose 419 additional content into the received video feed, prior to the video feed being sent to the communication device. The additional content which is superimposed can include logos, branding, lettering, captions, backdrops, and the like. Techniques for superimposing content onto a video feed are known. The content can be superimposed by providing the additional content with instructions to the transcoding unit, where the transcoding unit has the capability of superimposing the content into the received video feed. Accordingly, one or more embodiments includes superimposing additional content into the received video feed, wherein the transcoded video feed which is transmitted to the video enabled communication device includes the additional content. Accordingly, one or more embodiments further includes superimposing additional content into the received video feed, wherein the transcoded video feed which is transmitted to the video enabled communication device includes the additional content.

Optionally, the processor 407 can be programmed to handle 421 DTMF tones from the communication device as video monitoring device control. As one example, the DTMF tones can be converted to a SIP information message with known camera control commands, routed through the transcoding unit, and transmitted to the video monitoring device, where the video monitoring device is enabled to respond to such SIP information messages. As another example, the DTMF tones can be interpreted as defined in a standard (for example RFC 2833, RFC 3660, RFC 4733, and later versions and adaptations), and transmitted to the video monitoring device along a SIP signaling path (routed through the SIP application server) to invoke control of the video monitoring device. As a third alternative, the DTMF tones can be routed through a conventional media server, where the translation and/or interpretation of the DTMF tones is performed (rather than at the network infrastructure device) using known techniques for such translation and/or interpretation. Accordingly, one or more embodiments further includes a video monitoring device control unit configured to facilitate: interpreting dual tone multi-frequency (DTMF) tones received from the video enabled communication device as video monitoring device control for the video monitoring device; and transmitting the video monitoring device control to the video monitoring device.

It should be understood that various logical groupings of functions are described herein. Different realizations may omit one or more of these logical groupings. Likewise, in various realizations, functions may be grouped differently, combined, or augmented. Furthermore, variations can distribute functions in different servers. For example, in a variation of the network infrastructure device 401, the transcoding 415 can be incorporated into the network infrastructure device 401, or can be provided by communicating with a separate transcoding unit.

Accordingly, one or more embodiments provides a network infrastructure system, wherein the network infrastructure system is included in a session initiation protocol (SIP) media communication path between a video enabled communication device and a video monitoring device. The network infrastructure system includes a transceiver operable to receive and transmit communications between a video enabled communication device and a video monitoring device, and a processor cooperatively operable with the transceiver. The processor is configured to facilitate: establishing a SIP session between the video monitoring device and a video enabled communication device; after the SIP session is established, providing instructions to receive, in accordance with a media path, a video feed from the video monitoring device, transcode the received video feed, and transmit, in accordance with the media path, the transcoded video feed to the video enabled communication device; and tearing down the SIP session, after the video monitoring device or the video enabled communication device is no longer in communication.

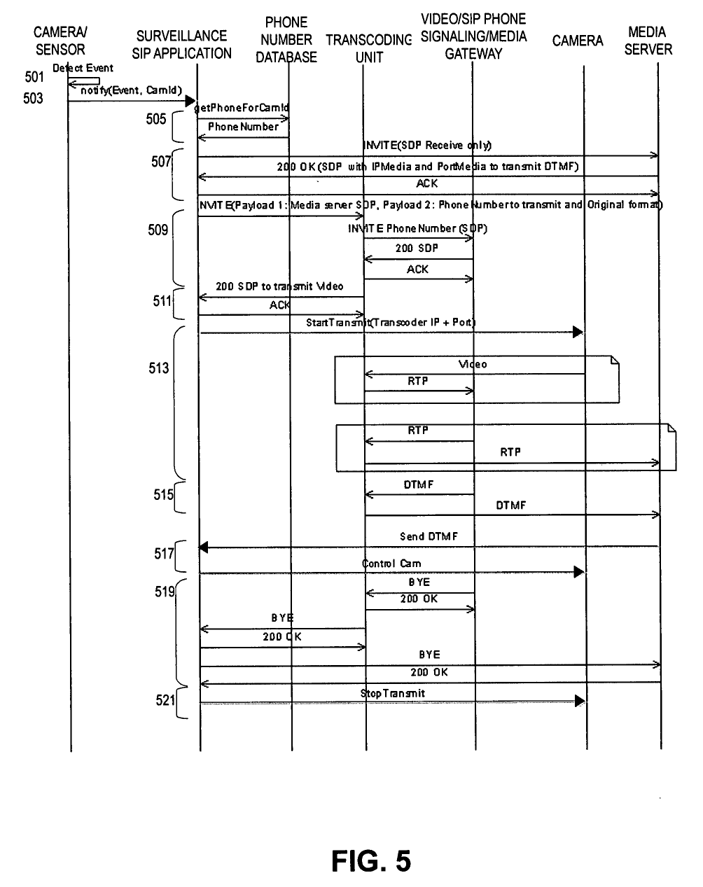

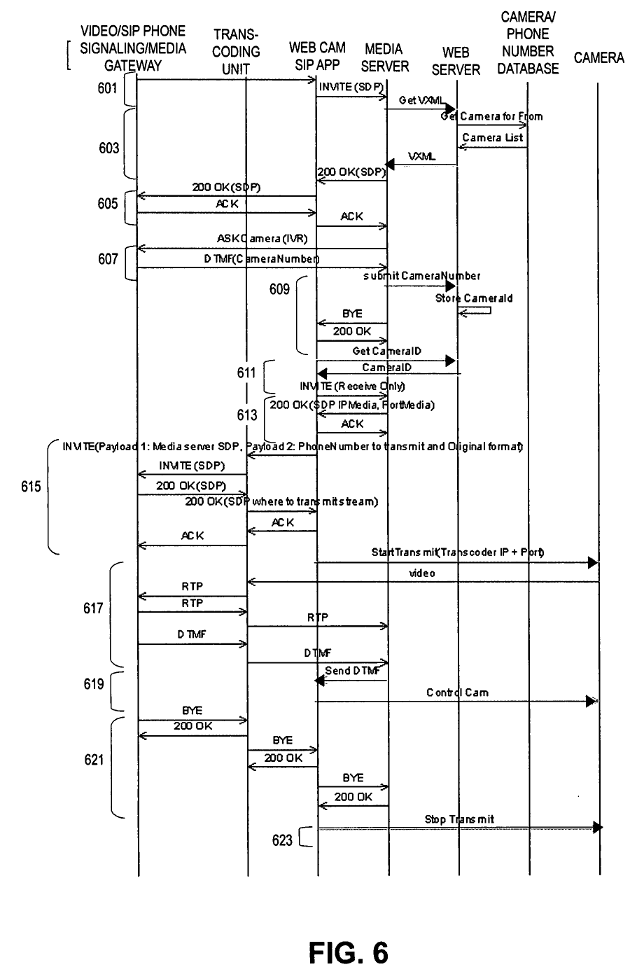

FIG. 5 and FIG. 6 provide exemplary protocol sequences for the surveillance system and the virtual nanny system, respectively. In the surveillance system, here represented by the “home surveillance system”, the communications between the video monitoring device and the video enabled communication device are initiated by the video-monitoring device (or sensor). On the other hand, in the system sometimes referred to as the virtual nanny system, the communications are initiated by the video enabled communication device.

Referring now to FIG. 5, a diagram illustrating a protocol sequence for home surveillance using the video monitoring device and the video enabled communication unit will be discussed and described. In this protocol, communications are made between a camera/sensor, a surveillance SIP application, a phone number database, a transcode unit, a video/SIP phone signaling/media gateway, a camera, and a media server. Each of these communications is discussed in more detail below.

An event is detected 501, by the camera/sensor (which can be a camera with unitary sensor or sensor in connection with the camera). A notification of the event 503 with indication of the event and a unique camera identifier is transmitted from the camera/sensor to a surveillance SIP application. The surveillance/SIP application can be operating on the camera (if so enabled), on a personal computer, on a media gateway, or similar.

In response to receiving the notification of the event, the surveillance SIP application obtains 505 contact information, for example the telephone number. In this example, the surveillance SIP application sends an ODBC (open database connectivity) command, or more particularly a JDBC (Java database connectivity) command to a database which stores the contact information correlated to the unique camera identifier, for example a telephone database. The database returns the requested contact information, for example the telephone number.

Having obtained the contact information, the surveillance SIP application uses SIP protocol to send 507 an INVITE (SDP receive only) to a network infrastructure device such as a SIP server, here represented by the media server. The media server transmits a 200 OK (SDP with IPMedia and PortMedia to transmit DTMF) to the surveillance SIP application upon successfully connecting to the media server. The surveillance SIP application responds to the media server with an ACK to acknowledge the 200 OK.

Still using SIP protocol, the surveillance SIP application sends 509 an INVITE with two payloads (payload: 1 media server SDP, payload 2: phone number to transmit and original format) to another network infrastructure device, here represented by the transcode unit. The transcode unit sends an INVITE (phone number (SDP)) with the telephone number, to establish a session with the video enabled communication device. The video enabled communication device responds with a 200 SDP to the transcode unit, and the transcode unit transmits an ACK to the video enabled communication device to acknowledge the 200 SDP. Thus, a SIP session is established between the video enabled communication device and video monitoring device.

Then, the transcode unit transmits 511 a 200 SDP communication to the surveillance SIP application, with a command in the transmission to commence transmitting video. The surveillance SIP application acknowledges the 200 SDP command with an ACK.

Then a video session 513 begins between the surveillance the video monitoring device and the video enabled communication device. The surveillance SIP application transmits a StartTransmit command (indicating transcoding unit IP and port), as a Java RMI (remote method invocation), web service, HTTP, or similar request, to the video monitoring device (such as a camera). The video monitoring device transmits a video stream to the transcoding unit, and the transcoding unit transcodes the video and transmits RTP communications with the transcoded video to the video enabled communication device. The transmission of video can be streamed in accordance with known techniques. Optionally, the video session allows the video enabled communication device to remotely control the video monitoring unit. As a first alternative for remote control, in this video session 513, the video enabled communication device can transmit an RTP communication to the transcode unit, which forwards the RTP communication to the media server. As a second alternative for remote control, in this video session 513, the video enabled communication device can transmit DTMF communications to the transcode unit, which forwards the DTMF communication to the media server.

Upon receiving a remote control (either DTMF or RTP), the media server can translate/transform the DTMF or RTP remote control to a format appropriate for the video monitoring device, and transmit 517 the remote control (here represented by a DTMF communication) to the surveillance SIP application, for example as a Java RMI, web service, or HTTP request. Upon receipt of the remote control, the surveillance SIP application can control the camera either directly or remotely, such as by RMI, web service, HTTP request, or similar. Accordingly, in one or more embodiments the interpreting includes interacting with a media server to translate the DTMF tones to the video monitoring device control for the video monitoring device. Moreover, one or more embodiments further includes a video monitoring device control unit configured to facilitate: receiving SIP information packets from the video enabled communication device to the video monitoring device, wherein the SIP information packets include video monitoring device control and indicate the video monitoring device to be controlled; and transmitting the SIP info packets to the indicated video monitoring device, so that the video monitoring device is controlled.

The session can be torn down, for example as shown in the termination sequence 519. In this example, the video enabled communication device transmits a BYE SIP command to the transcode unit, which responds with a 200 OK. Then the transcode unit transmits a BYE SIP command to the surveillance SIP application, which responds with a 200 OK. Then the surveillance SIP application transmits a BYE SIP command to the media server, which responds with a 200 OK. Accordingly, the video enabled communication device, transcode unit, media server, and surveillance SIP application are all terminated from the SIP session.

Then, the surveillance SIP application sends a stop transmit 521 command as a Java RMI, web service, or HTTP request to the camera. In response, the camera stops transmitting video.

Referring now to FIG. 6, a diagram illustrating a protocol sequence for monitoring the video monitoring device will be discussed and described. In this protocol, communications are made between a video/SIP phone signaling/media gateway, a transcode unit, a webcam SIP application, a media server, a camera/phone number database, and a camera. Each of these communications is discussed in more detail below.

In this example, the SIP phone transmits 601 an INVITE (SDP) SIP communication to the webcam SIP application. The webcam SIP application can be operating on the SIP phone (if so enabled), on a personal computer connected to the phone (such as a softphone), on a media gateway, or similar. The webcam SIP application then transmits an INVITE (SDP) SIP command to a network infrastructure device such as a SIP server, here represented by the media server.

The media server transmits 603 a Get VXML command as an HTTP communication to the web server. The web server sends an ODBC (open database connectivity) command, or more particularly a JDBC (Java database connectivity) command to a database which stores information for the camera(s) correlated to the unique SIP phone identifier, for example as a list of camera contact information. The database returns the requested contact information, for example the list of cameras and the contact information for the cameras. Then, the media server transmits a 200 OK (SDP) as a SIP command to the webcam SIP application.

The webcam SIP application transmits 605 a 20 OK (SDP) SIP communication to the SIP phone, which responds with an ACK. The webcam SIP application transmits an ACK to the media server.

Optionally, the media server then transmits 607 an ASK Camera (IVR) query to the SIP phone, to instruct the SIP phone to interact with the user to determine which camera number is to be connected. The SIP phone returns DTMF tones with the camera number.

The media server submits 609 the camera number to the web server as an HTTP command. The web server stores the camera identifier for later use. The media server then terminates, by transmitting a BYE to the web can SIP application, and receiving a 200 OK.

The webcam SIP application transmits 611 an HTTP request for the camera identifier to the web server, which responds with the camera identifier.

The webcam SIP application then transmits 613 a SIP INVITE (receive only) to the media server. The media server responds with a 200 OK (SDO IP media, FortMedia) SIP response. The webcam SIP application transmits an ACK to the media server.

The webcam SIP application then proceeds 615 to connect together the SIP phone, the transcode unit, and the camera. The webcam SIP application transmits to the transcode unit an INVITE with a first payload of media server SDP, and a second payload of phone number to transmit and original format. In response, the transcode unit transmits an INVITE (SDP) to the SIP phone, which responds with a 200 OK (SDP). The transcode unit responds to the webcam SIP application with a 200 OK (SDP where to transmit stream). The webcam SIP application transmits an ACK to the transcode unit, and the transcode unit transmits an ACK to the SIP phone. The video feed from the camera to the SIP phone now can begin.

To begin a video session, the webcam SIP application transmits an RMI, web service, HTTP request, or similar to the camera instructing the camera to start transmit, indicating the transcoding unit IP address and port number. The camera then begins transmitting a video stream to the transcoding unit, and the transcoding unit transcodes the video and transmits RTP communications with the transcoded video to the SIP phone.

Optionally, the video session allows the SIP phone to remotely control the camera 617. As a first alternative for remote control, during the video session, the SIP phone can transmit an RTP communication to the transcode unit, which forwards the RTP communication to the media server. As a second alternative for remote control during the video session, the video enabled communication device can transmit DTMF communications to the transcode unit, which forwards the DTMF communication to the media server.

Upon receiving a remote control (either DTMF or RTP), the media server can translate/transform the DTMF or RTP remote control to a format appropriate for the camera, transmits 619 the remote control (here represented by a DTMF communication) to the SIP webcam application, for example as a Java RMI, web service, or HTTP request. Upon receipt of the remote control, the SIP webcam application can control the camera either directly or remotely, such as by RMI, web service, HTTP request, or similar.

The session can be torn down, for example as shown in the termination sequence 621. In this example, the SIP phone transmits a BYE SIP command to the transcode unit, which responds with a 200 OK. Then the transcode unit transmits a BYE SIP command to the webcam SIP application, which responds with a 200 OK. Then the webcam SIP application transmits a BYE SIP command to the media server, which responds with a 200 OK. Accordingly, the video enabled communication device, transcode unit, media server, and surveillance SIP application are all terminated from the SIP session.

Then, the webcam SIP application sends a stop transmit 623 command as a Java RMI, web service, or HTTP request to the camera. In response, the camera stops transmitting video.

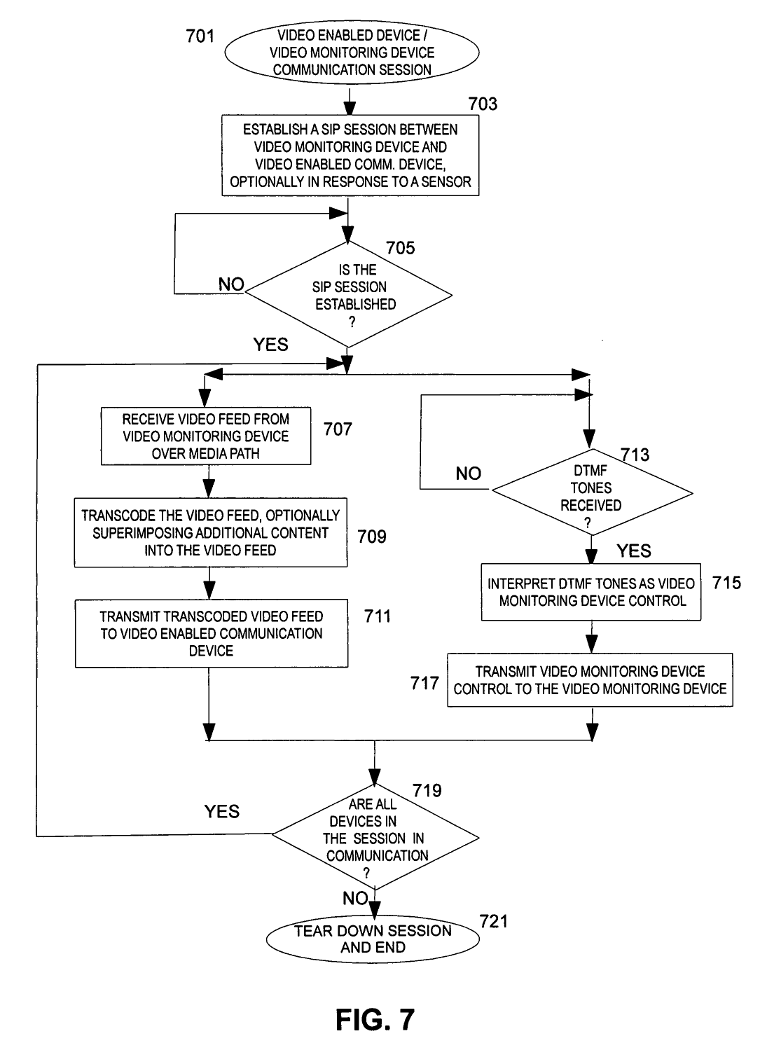

Referring now to FIG. 7, a high level flow chart illustrating a procedure for a video enabled communication device/video monitoring device communication session will be discussed and described. The procedure can advantageously be implemented on, for example, a computer system including a processor of one or more network infrastructure devices, described in connection with FIG. 4 or other apparatus appropriately arranged. Note that the procedure can be distributed to multiple processors on different network infrastructure devices.

In overview, the procedure 701 includes establishing 703 a SIP session between the video monitoring device and the video enabled communication device. Once the SIP session is established, the procedure 701 handles the video feed reception 707, transcoding 709, and transmission 711 to the video enabled communication device, as well as handles remote control of the video monitoring device via receiving 713 DTMF tones, interpreting 715 the DTMF tones, and transmitting 717 remote controls to the video monitoring device. When a device exits 719 the session, the procedure 701 tears down 721 the session and ends. Each of these is explained in more detail below.

The procedure 701 can establish 703 a SIP session between the video monitoring device and the video enabled communication device. The SIP session can be established in accordance with known techniques, to include the video monitoring device and the video enabled communication device. The SIP session can be established at the communication device end, such as discussed in connection with the “virtual nanny” or “dial-a-web-cam” system. Alternatively, the SIP session can be established at the video monitoring device end, in response to a sensor being triggered by a predetermined condition, such as discussed in connection with the home or office surveillance system. As explained below, the SIP session optionally can be established to include other processors of different network infrastructure devices.

Once the SIP session is established, the procedure 701 handles the video feed reception 707, transcoding 709, and transmission 711 to the video enabled communication device. In particular, the video feed is received 707 from the video monitoring device over the media path. Then, the video feed is transcoded 709. Also, optionally additional content is superimposed into the video feed (as explained above). Then the transcoded video feed (with optional superimposed content) is transmitted 711 to the video enabled communication device. The video enabled communication device can display the video feed. The video feed reception, transcoding, and transmission can advantageously be performed via a transcoding unit, which can be running on the same or a different network infrastructure device. If the transcoding unit is on a different network infrastructure device, then the procedure 701 can handle the video feed reception, transcoding, and transmission by transmitting an appropriate command to the transcoding unit, with an indication of the contact information of the video enabled communication device and the video monitoring device. The procedure 701 can obtain information indicating video format utilized by the video monitoring device and video format utilized b the video enabled communication device, which can be different, so that the video feed can be appropriately transcoded. This information can be provided to the optional transcoding unit for use in transcoding.

The procedure 701 also handles remote control of the video monitoring device via receiving 713 DTMF tones from the video enabled communication device, interpreting 715 the DTMF tones to remote control commands appropriate for the video monitoring device, and transmitting 717 the remote control commands to the video monitoring device. As described above, it may be advantageous to utilize a different network infrastructure device to process the DTMF tones. Thus, it is possible for the DTMF tone reception 713, DTMF tone interpretation 715, and transmission 717 of video control to occur in parallel to the handling of the video feed 707, 709, 711. Examples of protocol sequences with DTMF tones were provided above in more detail, for example in connection with FIG. 5 and FIG. 6, and will not be repeated here.

When a device exits 719 the session, the procedure 701 tears down 721 the session and ends. Examples of a session tear down were discussed in more detail in connection with FIG. 5 and FIG. 6 and the discussion will not be repeated here.

Variations can be made utilizing the above-discussed principals, and still be within the scope of the discussion. For example, other protocols can be utilized to achieve the same end-to-end solution, such as Parlay X, or other proprietary protocol or softswitch API. Instead of using SIP to make the call to the user phone, use any protocol or API.

As another example other triggers can be utilized, such as weight change trigger, wind speed/direction trigger. More generally, any device that is connected on the network can send an alert to the server application, via RMI or web service. The server application can call the user and send the video stream of the associated camera to the device.

Also, in an embodiment, an advertisement can be inserted before, after or during the video stream, and/or a video can be streamed before or after the live stream.

Furthermore, a variation can stream multiple video streams from different cameras at the same time. A video stream mixer can obtain streams from multiple cameras, and can sends only one stream to the user device.

As another example, the video can be streamed to any other video device, for example, a TV Setup box, or an Instant messaging application. This could be done by associating the camera identifier to a Setup Box ID or an Instant messaging ID and by using an existing API to stream the video at the right place.

In addition, in various embodiments, the sound can also be sent with the video stream. In this case, the sound can be included in the RTP, with the video stream.

It should be noted that the term communication unit may be used herein interchangeably herein with communication device, subscriber unit, wireless subscriber unit, wireless subscriber device, phone, or the like. Each of these terms denotes a device ordinarily associated with a user and typically a wireless mobile device that may be used with a public network, for example in accordance with a service agreement, or within a private network such as an enterprise network, or a wireline device on a network. Examples of such units include a cellular handset or device, a personal digital assistant, a personal assignment pad, and a personal computer equipped with softphone, or equivalents thereof, provided such units are arranged and constructed for receipt and display of a video feed.

The term video monitoring device is used herein to indicate devices sometimes referred to as cameras, video monitors, webcams, web cameras, video cameras, and the like, which are configured to capture periodic images or continuous frames, thereby continually providing new images that are transmitted in rapid succession or, in some cases, as streaming video, and which can be displayed by a device receiving the images. Frequently, the images are captured in accordance with JPEG or MPEG file formats. Some of the video monitoring devices are equipped with the ability to receive commands to control the camera (zoom, tilt, pan, and so forth).

A “video feed,” sometimes referred to as a “video stream,” is defined as the sequential images (whether periodic images or continuous frames) transmitted by a video monitoring device, for display at a different device. The video feed can be transmitted in real time so that a user can see what is happening as it happens. A video feed can include data images transmitted for example as RTP packets. A video feed is to be distinguished from an individual still image.

“Transcoding”, as used herein is defined as re-purposing video, typically from an input format into a target format, where the target format is a format and/or viewing media that can be different from the input format. Generally, the original input data can be decoded or decompressed to a raw intermediate format in a way that mimics the standard playback of the coding of the original digital or analog video signal, and which is then recoded into the target format. Various technologies are commercially available which can provide such transcoding.

Furthermore, the communication networks of interest include those that are capable of transmitting information in packets, for example, those known as packet switching networks that transmit data in the form of packets, where messages can be divided into packets before transmission, the packets are transmitted, and the packets are routed over network infrastructure devices such as routers, transfers and gateways to a destination where the packets are recompiled into the message. Such networks include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, ATM (Asynchronous Transfer Mode), IEEE 802.11, UDP/UP (Universal Datagram Protocol/Universal Protocol), home plug, HPNA, MOCA, WiFi, and other wireless application protocols, and/or other protocol structures, and variants and evolutions thereof. Such networks can incorporate wireless communications capability and/or utilize wireline connections such as cable and/or a connector, or similar.

The communication systems, communication devices, and video monitoring devices of particular interest are those providing or facilitating video communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 3G and 3.5G systems such as UMTS (Universal Mobile Telecommunication Service) systems, Internet Protocol (IP) Wireless Wide Area Networks like 802.16, 802.20, HSDPA (High Speed Downlink Packet Access) systems, or Flarion, integrated digital enhanced networks and variants or evolutions thereof.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of communicating a video feed transmitted from a video monitoring device to a video enabled communication device, wherein the video enabled communication device and the video monitoring device communicate via a communication network in a session initiation protocol (SIP) session, the method comprising:
establishing, in accordance with a SIP initiation path, a SIP session between the video monitoring device and the video enabled communication device;
after establishing the SIP session, receiving, in accordance with a media path between the video monitoring device and the video enabled communication device, a video feed from the video monitoring device;
transcoding the received video feed; and
transmitting, in accordance with the media path, the transcoded video feed to the video enabled communication device.

2. The method of claim 1, wherein the establishing of the SIP session is initiated by the video enabled communication device.

3. The method of claim 1, further comprising:
interpreting dual tone multi-frequency (DTMF) tones received from the video enabled communication device as video monitoring device control for the video monitoring device; and
transmitting the video monitoring device control to the video monitoring device.

4. The method of claim 3, wherein the interpreting includes interacting with a media server to translate the DTMF tones to the video monitoring device control for the video monitoring device.

5. The method of claim 1, further comprising:
receiving SIP information packets from the video enabled communication device to the video monitoring device, wherein the SIP information packets include video monitoring device control and indicate the video monitoring device to be controlled; and
transmitting the SIP info packets to the indicated video monitoring device, so that the video monitoring device is controlled.

6. The method of claim 1, wherein the transcoding is performed in a transcoding unit at a network infrastructure device routing communications in the media path.

7. The method of claim 1, further comprising superimposing additional content into the received video feed, wherein the transcoded video feed which is transmitted to the video enabled communication device includes the additional content.

8. A method of communicating a video feed transmitted from a video monitoring device to a video enabled communication device, wherein the video enabled communication device and the video monitoring device communicate via a communication network in a session initiation protocol (SIP) session, and wherein a sensor communicates via the communication network, the sensor being triggered by a predetermined condition, the method comprising:
establishing in accordance with a SIP initiation path, a SIP session between the video monitoring device and the video enabled communication device, wherein the SIP session is initiated by a sensor being triggered by a predetermined condition;
after establishing the SIP session, receiving, in accordance with a media path between the video monitoring device and the video enabled communication device, a video feed from the video monitoring device; and transmitting, in accordance with the media path, the received video feed to the video enabled communication device.

9. The method of claim 8, further comprising:
interpreting dual tone multi-frequency (DTMF) tones received from the video enabled communication device as video monitoring device control for the video monitoring device; and
transmitting the video monitoring device control to the video monitoring device.

10. The method of claim 9, wherein the interpreting includes interacting with a media server to translate the DTMF tones to the video monitoring device control for the video monitoring device.

11. The method of claim 8, further comprising:
receiving SIP information packets from the video enabled communication device to the video monitoring device, wherein the SIP information packets include video monitoring device control and indicate the video monitoring device to be controlled; and
transmitting the SIP info packets to the indicated video monitoring device, so that the video monitoring device is controlled.

12. The method of claim 8, further comprising transcoding the received video feed, wherein the video feed that is transmitted to the video enabled communication device has been transcoded, wherein the transcoding is performed in a transcoding unit at a network infrastructure device routing communications in the media path.

13. The method of claim 12, further comprising superimposing additional content into the received video feed, wherein the received video feed which is transmitted to the video enabled communication device includes the additional content.

14. A network infrastructure system, wherein the network infrastructure system is included in a session initiation protocol (SIP) media communication path between a video enabled communication device and a video monitoring device, comprising:
a transceiver operable to receive and transmit communications between a video enabled communication device and a video monitoring device; and
a processor cooperatively operable with the transceiver, and configured to facilitate:
establishing a SIP session between the video monitoring device and a video enabled communication device;
after the SIP session is established, providing instructions to receive, in accordance with a media path, a video feed from the video monitoring device, transcode the received video feed, and transmit, in accordance with the media path, the transcoded video feed to the video enabled communication device; and
tearing down the SIP session, after the video monitoring device or the video enabled communication device is no longer in communication.

15. The network infrastructure system of claim 14, further comprising a transcoding unit, wherein the SIP session is established further including a transcoding unit, the instructions to receive, transcode, and transmit are provided to the transcoding unit.

16. The network infrastructure system of claim 14, wherein the transcoding is performed in a transcoding unit at a network infrastructure device routing communications in the media path.

17. The network infrastructure system of claim 14, further comprising superimposing additional content into the received video feed, wherein the transcoded video feed which is transmitted to the video enabled communication device includes the additional content.

18. The network infrastructure system of claim 14, further comprising a video monitoring device control unit configured to facilitate:
interpreting dual tone multi-frequency (DTMF) tones received from the video enabled communication device as video monitoring device control for the video monitoring device; and
transmitting the video monitoring device control to the video monitoring device.

19. The network infrastructure system of claim 18, wherein the interpreting includes interacting with a media server to translate the DTMF tones to the video monitoring device control for the video monitoring device.

20. The network infrastructure system of claim 14, further comprising a video monitoring device control unit configured to facilitate:
receiving SIP information packets from the video enabled communication device to the video monitoring device, wherein the SIP information packets include video monitoring device control and indicate the video monitoring device to be controlled; and
transmitting the SIP info packets to the indicated video monitoring device, so that the video monitoring device is controlled.

21. The network infrastructure system of claim 14, wherein the SIP session is initiated by a sensor being triggered by a predetermined condition.
